(19) United States
(12) Patent Application Publication
(10) Pub. No.: US 2006/0234688 A1
(43) Pub. Date: Oct. 19, 2006

(54) Method and system for communicating user identification information

(76) Inventor: Mark Snyder Holmes, Atherton, CA (US)

Correspondence Address: Mark Holmes, 172 Encinal Avenue, Atherton, CA, 94027, US

(21) Appl. No.: 11/105,805

(22) Filed: Apr. 13, 2005

(51) Int. Cl. H04Q 7/22; H04Q 7/38; H04B 1/38

(52) U.S. Cl. 455/414.3; 455/557; 455/414.1

(57) ABSTRACT

A method and system for communicating user identification information comprising steps of transmitting or receiving signals including at least one parameter to identify users interests from or at a first device; identifying one or more second devices according to the signal parameters, and selectively connecting identified devices.

### BACKGROUND OF THE INVENTION

The present invention relates to a method and system for communicating common interest user identification information and, more particularly, to allowing users to identify users of devices with certain identifying data, such as the presence within a specified geographical area (e.g., a restaurant, neighborhood vicinity, city, state, etc.) of users of the same profession (e.g., dentists, patent attorneys, engineers, etc.), fraternity, alumni organizations, professional organizations (e.g., AIPLA), schools (e.g., fellow high school students etc.), hobbies (i.e., fisherman, aviators, computer gamers), military background (e.g., Gulf War veterans, Marines etc.), handicaps (e.g., diabetics, amputees etc.), religion (e.g., other Buddhists), nationalities (e.g., Scotsmen, Iranians etc.).

When a person enters a bar, restaurant, city or state, she may not know anyone, but would like to meet people. It is nearly impossible to know whether strangers share a common interest or bond. Few people feel comfortable approaching strangers and initiating a conversation. It is also impractical to approach a stranger and inquire if he or she has something in common with herself. If she knew there were people within a certain geographical area (i.e., bar, restaurant, city or state) who shared something in common (i.e., a common hobby, membership or alma mater), she would be more comfortable meeting such persons. It is also likely that people, who share something in common with a stranger, will be more receptive to the stranger's overtures.

People who participate in the database are more likely to welcome the contact as they have taken the affirmative step of making their information available to such contact.

The data is instantaneously available so that a person entering a bar or restaurant may immediately learn if anyone else present in the specified geography possesses a common interest.

One solution is to contact the shared organization and inquire if there are members present in a particular geographical area.

Another solution is to advertise in the classified sections of the traditional and online media for people who share a common interest, profession, alma mater, fraternity or hobby.

A further solution is to contact a directory of people for finding desirable details of common interest.

The drawback with consulting a directory is that they are often out-dated, onerous, time-consuming, and available only on-line or in expensive hard copy versions without instantaneous access.

In addition, such directory-based solutions do not provide information relating to the instantaneous location of the person of interest.

U.S. Patent Publication No. 20030021242A1 discloses an invention that provides a method for a facility communication system to provide a targeted electronic communication to a user. According to this method a personal wireless device having a transceiver is provided which is capable of storing user specific information in a storage location. Further the method includes steps of recognizing the presence of the personal wireless device transceiver within a predetermined distance from the facility communication system, which is non-mobile. On such recognition the facility communication systems sends a request to the said wireless device for retrieving the user specific information. On such retrieval the facility communication system compares user specific information to predetermined criteria and sends a targeted electronic communication to the personal wireless device corresponding to the user specific information. However this invention categorically demands a need of a database non-mobile server for comparing the user specific information. Further the method of this invention does not include any step or provision for identifying a second personal wireless device, based on the user specific information also does not include any step of connecting two wireless devices.

U.S. Patent Publication No. 20030027526A1 discloses a system and method for allowing connection between two or more peer-to-peer wireless devices no knowledge or pre-configuration of client/server roles. However this invention is limited to only connecting two wireless devices it does not include step of selectively connecting wireless devices or identifying a wireless device according to user's interest.

U.S. Patent Publication No. 20030224793A1, a method for mobile ad hoc networks is provided for selective networking or selectively connecting one or more wireless devices. In this method the concept of having one wireless device as a master device, which selectively connects to other (slave) devices by assigning then sequentially weight-age is used. Further this invention does not disclose anything that would enable a user to identify a person according to his interest.

U.S. Pat. No. 6,816,067 provides a method and apparatus for identifying and selecting a desired wireless device from multiple available wireless devices. In this method a first wireless device receives a signal from a searching wireless device. An indicator on the first wireless device is activated in a unique identification pattern that is recognized by the user of the searching wireless device. In this manner the user may verify that the first wireless device is receiving the signal from the searching wireless device. Again this invention only provides a method that enables a connection between wireless devices and does not address selectively connecting two wireless devices according to the user's interest.

U.S. Pat. No. 6,640,098 discloses a system for obtaining service-related information for local interactive wireless devices by sending and receiving a ping signal to and from a wireless device.

U.S. Patent Publication No. 20030117316A discloses a systems and methods for locating and tracking a wireless device which is only limited to locating a wireless device.

U.S. Patent Publication Nos. 20030013434A1, 20030143991A1 and US20040067773A1 provide a method or system, or both, for either activating wireless services, or updating database or selecting an application using wireless devices. These do not provide any solution to address connectivity between two wireless devices according to the interest of the user, further these methods rely on a common interface or a server for connecting devices.

U.S. Patent Publication No. 20040014423A1 provides a method in which individual wireless devices communicate amongst each other exchanging identity information, authentication-state or both, thereby forming a collaborative-collection of wireless devices for improving for efficiently handling group activities.

U.S. Pat. No. 6,714,778 provides context sensitive web services. The context sensitive web services method enables a mobile phone or wireless device to use context inference techniques to sense the user's environment and in response, to provide useful information to the user that is appropriate to the user's perceived environment.

U.S. Pat. No. 6,490,291 discloses method and device for data communications between a Wireless Application Protocol (WAP) terminal and a WAP server. The data communications device includes: a plurality of WAP terminals each having a protocol stack in which a Circuit Switch Data service (CSD) protocol layer is laid under a Wireless Transaction Protocol (WTP) layer and a Wireless Datagram Protocol (WDP) layer, for generating WAP data which is service request data; a plurality of WAP servers each having a protocol stack in which a Transmission Control Protocol (TCP) layer and an Internet Protocol (IP) layer are laid under a WTP layer and a WDP layer, for providing the WAP terminals with WAP server data according to the WAP data; and an interworking function (IWF) unit having a CSD protocol layer connected to the CSD protocol layers of each WAP terminal, and a TCP layer and an IP layer which are connected to the TCP and IP layers of each WAP server, for mapping the WAP terminals to the corresponding WAP servers, wherein each WAP terminal communicates with the IWF unit though a single Internet Protocol/Peer-to-Peer Protocol (IP/PPP) layer included in its own CSD protocol layer, and the IWF unit communicates through the Internet with each WAP server. Because there is no redundancy of IP/PPP protocol layers in the WAP terminal, overhead is considerably reduced. Also, the IWF unit is directly connected through the Internet to the WAP server, not through the PSTN and the ISP, so that connection time and costs can be reduced.

U.S. Pat. No. 6,748,195 discloses the wireless device having a receiver and transmitter that communicate information with other devices over the wireless links. The wireless device uses profiles that are associated with one or more contexts. The contexts can define various situations under which the wireless device operates. Depending on a context, the wireless device changes its operational behavior in accordance with a defined profile, for example, when a context parameter changes. Among other things, the context can correspond to a wireless device location, user age, skill, or gender, or even ambient environmental factors, such as temperature. For example, based on a profile associated with a location, the wireless device can change its operational behavior relative to sharing resources with other devices. Other contexts could include wireless network connectivity capability, ID and type of “communicated to” device. The profile associated with a context can have one or more parameters that define the operational behavior of the wireless device in terms of one or more operating modes of the wireless device. The operating modes of the wireless device can relate to its discoverability, connectability, pairing, security, and idle modes, among other things.

U.S. Patent Publication No. 20040002343A1 discloses a wireless network permitting wireless devices to determine their own location and receive location-based services. The network includes a communication server coupled to a plurality of access points and at least one mobile wireless device that wirelessly communicates through the access points. Each wireless device includes a location table through which the wireless device can determine its physical location. The location table includes the physical location of the various access points indexed by their network addresses. When the wireless device communicates with an access point, the access point provides the wireless device its address. The wireless device uses the address of the access point as an index into the location table to determine its own location based on the location of the access point. Once the wireless device has determined its own physical location, it requests location-based services from or through the communication server.

U.S. Patent Publication No. 20040203766A1 discloses an invention for basically identify and already registered user is available online. The invention provides method and device for establishing a communication interface for a communication session. In a communication system, a wireless device receives presence information, associated with a first party. Operated by a second party, the wireless device generates a notification (visual, audio or physical) to alert the second party. The noticification corresponds to the presence information associated with the first party. Based on the presence information, the wireless device provides the communication interface for the communication session between the first and second party.

In an article published in MITSloan Management Review, Fall 2004 Vol. 46 No. 1 discloses a system relied totally on Bluetooth™ technology and has designed his product such that it runs passively in the background of many Bluetooth™ phones, in addition his product necessarily requires a computer server in order to function. According to this product it is mandatory for the users to register their profile in the computer server, the server than identifies matching profiles and sends message to the users depending upon the availability of the user in its range and independent of their request for receiving such messages. This document does not describe any mechanism for connecting two wireless devices directly independent of any server. Furthermore, this product does not offer options to compile/create a request according to the user's requirements.

None of the above disclosures provide a solution that would allow a user to have information about the presence of other users according to the choice of his/her selection.

Therefore, there is a need for a method and system that allows a user of a device to immediately learn if another user of another device fitting certain criteria is located within a certain geographical area.

There is a need of method and system that allow people to learn if there are other people with similar interests present within a certain geographical area.

Furthermore there is a need of a method and system that facilitates business and social interactions by allowing introductions between people.

In addition there is a need for a method and system that allow shy people to meet strangers through a common interest via their wireless devices.

Along with the above it is observed that there is a need of devices to execute above method.

### SUMMARY OF THE INVENTION

It is therefore an object of the invention to allow people to immediately learn if another person fitting certain criteria is located within a certain geographical area through a wireless device.

It is another object of the invention to allow people to learn if there are other people with similar interests present within a certain geographical area.

It is yet another object of the invention to facilitate business and social interactions by allowing introductions between people.

It is an additional object of the invention to allow shy people to meet strangers through a common interest via wireless devices.

It is a further object of the invention to provide one or more device for achieving the above and other objects of the invention.

To achieve the above and other objects, the present invention provides a method for communicating user specified identification information between wireless devices within an identified geographical area. The user specified information may be a common background, alma mater, fraternity, sorority, hobby, or any other mutual interest or background.

The present invention provides a method for communicating user identification information comprising steps of transmitting or receiving signals including at least one parameter to identify user's interests from or at a first device; identifying one or more second devices according to the signal parameters, and selectively connecting identified devices.

The invention provides a method for communicating user identification information wherein said first and second devices include wireless devices or a common interface system for connecting wireless devices or any combination thereof.

The invention provides a method for communicating user identification information wherein said step of receiving signals at a first device includes steps of storing received signal parameters for instantly identifying one or more second devices according to the signal parameters and for future reference.

The invention provides a method for communicating user identification information between wireless devices wherein said step of identifying includes step of comparing signal parameter of the devices.

The invention provides a method for communicating user identification information between wireless devices wherein said step of selectively connecting provides options for instantly connecting said devices or storing user identification for future reference at one or more devices or communicating user identification or any combination thereof.

The invention provides a method for communicating user identification information between wireless devices wherein said step of selectively connecting includes step of connecting said devices through a common interface system.

The invention provides a method for communicating user identification information between wireless devices wherein said step of receiving signals includes receiving signals at a common interface system and storing received signal parameters for instantly identifying one or more second devices according to the signal parameters and for future reference.

The invention provides a method for communicating user identification information between wireless devices wherein said step of identifying includes step of comparing signal parameters and stored parameters of common interface.

The invention provides a method for communicating user identification information between wireless devices wherein said parameters may include geographical area, profession, fraternity, alumni organizations, professional organizations, schools, hobbies, military background, handicaps, religion, nationalities, or any other parameters or any combination thereof to identify a user's interest.

The present invention provides a common interface system for communicating user identification information between wireless devices comprising, means for receiving signals including at least one parameter to identify users interests from a first wireless device, means for identifying one or more second wireless devices according to the received signal parameters, means for communicating user identification to one or more wireless devices.

The invention provides a common interface system for communicating user identification information between wireless devices wherein said system further comprising means for selectively connecting identified first and second wireless devices.

The invention provides a common interface system for communicating user identification information between wireless devices wherein said means for receiving signals from a first wireless device includes means for storing received signal parameters for instantly identifying one or more second devices according to the signal parameters and for future reference.

The invention provides a common interface system for communicating user identification information between wireless devices wherein said means for identifying includes means for comparing signal parameters.

The invention provides a common interface system for communicating user identification information between wireless devices wherein said step of selectively connecting provides options for instantly connecting said devices or communicating user identification for future reference to one or more devices.

The invention provides a wireless device for communicating user identification information comprising, means for transmitting or receiving signals including at least one parameter to identify users interests from or at a first device, means for identifying one or more second devices according to the signal parameters, and means selectively connecting first and identified devices.

The invention provides a wireless device for communicating user identification information wherein said first and second devices include wireless devices or a common interface system for connecting wireless devices or any combination thereof.

The invention provides a wireless device for communicating user identification information wherein said means for transmitting or receiving signals at a first device includes steps of storing received signal parameters for instantly identifying one or more second devices according to the signal parameters and for future reference.

The invention provides a wireless device for communicating user identification information wherein said means for identifying includes means for comparing signal parameter of the devices.

The invention provides a wireless device for communicating user identification information wherein said means for selectively connecting provides options for instantly connecting said devices or storing user identification for future reference at one or more devices or both instantly connecting and storing user identification.

The invention provides a wireless device for communicating user identification information wherein said means for selectively connecting includes means for connecting said devices through a common interface system.

The invention provides a wireless device for communicating user identification information wherein said means for selectively connecting provides options for instantly connecting said devices or communicating user identification to one or more devices for future reference.

The invention provides a wireless device for communicating user identification information wherein said device is provided with means for transmitting includes means for compiling or generating signals including at least one parameter to identify users interests.

The invention provides a program product for communicating user identification information for wireless devices comprising a signal generator for setting preferences of said wireless device and generating signals including at least one parameter to identify users interests receiving inputs from compiling means providing its output to a transmitting or receiving means, a comparator receiving its input from said receiving means for identifying one or more devices according to set preference and connector for selectively connecting identified devices.

The invention provides an apparatus for communicating user identification information for common interface system comprising a receiving means for receiving and storing signal and device information, a comparator receiving its input from said receiving means and stored information for identifying one or more devices according signal parameters and transmitting means for communicating user identification information connector for selectively connecting identified devices.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram in accordance with an exemplar embodiment of the invention for communicating user identification through a common interface system.

FIG. 2 is a diagram accordance with a second possible exemplar of the invention for communicating user identification directly from one device to a second device.

### DESCRIPTION OF THE PREFERRED EMBODIMENT

The invention relates to a means for users of wireless devices to communicate certain common traits, interests and backgrounds to other users.

The present invention will become more fully understood from the detailed description given below and the accompanying drawings which are given by way of illustration only, wherein like reference numerals designate corresponding parts in the various drawings, and wherein:

Devices include: telephone, cell phones, personal communication devices, PDA's, laptops, computers etc.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

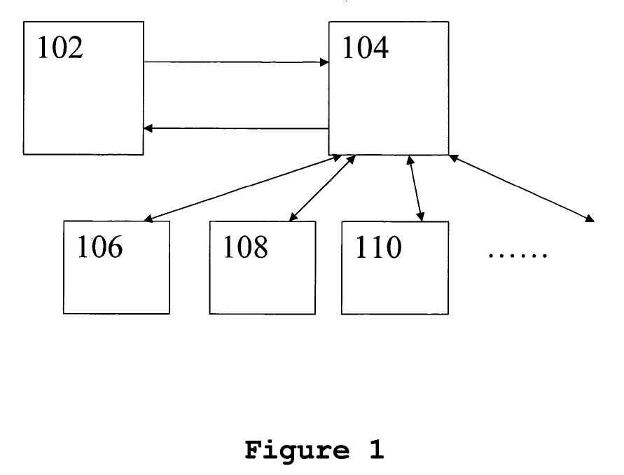

FIG. 1 is a block diagram in accordance with a first embodiment of the invention for communicating user identification through a common interface system. According to the invention a first wireless device 102 can transmit a signal including at least one signal parameter to identify a first user's information, including personal information or interests from the first wireless device 102 and operatively connect (“operatively connect” is defined to include wireless or a physical connection) to a common interface system 104 that requests the common interface system 104 to identify a second device 106, 108, 110 . . . n according to the signal parameter. The common interface system 104, after identifying one or more second device 106, 108, 110 . . . n communicates a second device 106, 108, 110 . . . n signal parameter to the first wireless device 102.

The common interface system 104 also optionally provides provision for distributing first device's 102 identification to the identified second users. In addition the common interface system also provides provisions for selectively connecting first device and identified second devices through the common interface system.

While transmitting signal parameters or subsequently received identification the first device 102 or identified devices have option to store the signal parameters for future references or identified device identifications, similarly the common interface 104 while receiving signal store the first device identification and desired parameter for future reference.

On receipt of a request for identifying a device the common interface system 104 identifies one or more devices by comparing stored parameters.

The signal parameters may include geographical area, profession, fraternity, alumni organizations, professional organizations, schools, hobbies, military background, handicaps, religion, nationalities, or any other parameters or any combination thereof to identify a user's interest.

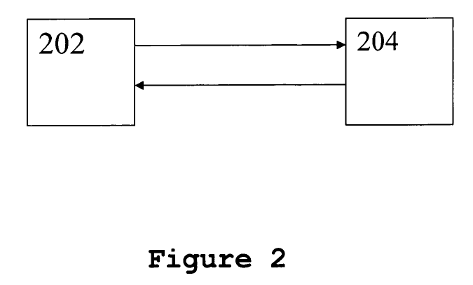

FIG. 2 is a block diagram accordance with a second possible embodiment of the invention for communicating user identification directly from one device to a second device. This embodiment operates on the wireless technologies like wifi™ or Bluetooth™ etc. According to this embodiment of the invention a first wireless device 202 transmits signals including at least one parameter to identify the users' interests from or at a first device that is then received by another one or more wireless devices 204. The wireless devices 204 then receive transmitted signals and compare the signal parameters and have an option to connect to the first wireless device if so desired.

The invention further provides program products for enabling operation described under FIG. 1 and FIG. 2.

The invention also provides a wireless device having said program embedded and a common interface system 104 having another program embedded for executing the invention.

The invention described herein is illustrative only and a person in the art will appreciate that other embodiments of the invention are also possible without deviating from the basic concept of the invention. Any such work out around the disclosed concept will also fall within the scope of this invention.

I claim:

1. A method for communicating user identification information comprising steps of:
transmitting or receiving signals including at least one parameter to identify users interests from or at a first device;
identifying one or more second devices according to the signal parameters; and
selectively connecting identified devices.

2. A method for communicating user identification information as claimed in claim 1 wherein said first and second devices include wireless devices and a common interface system for connecting wireless devices or any combination thereof.

3. A method for communicating user identification information as claimed in claim 1 wherein said step of receiving signals at said first device includes steps of storing received signal parameters for instantly identifying one or more second devices according to the signal parameters and for future reference.

4. A method for communicating user identification information as claimed in claim 1 wherein said step of identifying includes step of comparing signal parameter of the devices.

5. A method for communicating user identification information as claimed in claim 2 wherein said step of selectively connecting provides options for instantly connecting said devices or storing user identification for future reference at a device and communicating user identification.

6. A method for communicating user identification information as claimed in claim 1 wherein said step of identifying includes step of identifying said first device.

7. A method for communicating user identification information as claimed in claim 2 wherein said step of selectively connecting includes step of connecting said devices through said common interface system.

8. A method for communicating user identification information as claimed in claim 7 wherein said step of receiving signals includes receiving signals at said common interface system and storing received signal parameters for instantly identifying one or more second devices according to the signal parameters and for future reference.

9. A method for communicating user identification information as claimed in claim 7 wherein said step of identifying includes step of comparing signal parameters and stored parameters of said common interface.

10. A method for communicating user identification information as claimed in claim 2 wherein said wireless devices include telephone, cell phones, personal communication devices, PDA's, laptops and other electronic devices.

11. A method for communicating user identification information as claimed in claim 1 wherein said parameters may include geographical area, profession, fraternity, alumni organizations, professional organizations, schools, hobbies, military background, handicaps, religion, nationalities, or any other parameters or any combination thereof to identify users interest.

12. A common interface system for communicating user identification information comprising:
means for receiving signals including at least one parameter to identify user's interests from a first wireless device;
means for identifying one or more second wireless devices according to the parameter; and
means for communicating user identification to one or more wireless devices.

13. A common interface system for communicating user identification information as claimed in claim 12 wherein said system further comprising means for selectively connecting identified first and second wireless devices.

14. A common interface system for communicating user identification information as claimed in claim 12 wherein said means for receiving signals from a first wireless device includes means for storing received signal parameters for instantly identifying one or more second devices according to the signal parameters and for future reference.

15. A common interface system for communicating user identification information as claimed in claim 12 wherein said means for identifying includes means for comparing signal parameters.

16. A common interface system for communicating user identification information as claimed in claim 13 wherein said step of selectively connecting provides options for instantly connecting said devices or communicating user identification for future reference to one or more devices.

17. A wireless device for communicating user identification information comprising:
means for transmitting or receiving signals including at least one parameter to identify user's interests from or at a first device;
means for identifying a second devices according to the signal parameters; and
means selectively connecting identified devices.

18. A wireless device for communicating user identification information as claimed in claim 17 wherein said first and second devices include a common interface system for connecting a wireless device.

19. A wireless device for communicating user identification information as claimed in claim 17 wherein said means for transmitting or receiving signals at a first device includes steps of storing received signal parameters for instantly identifying one or more second devices according to the signal parameters and for future reference.

20. A wireless device for communicating user identification information as claimed in claim 17 wherein said means for identifying includes means for comparing signal parameter of the devices.

21. A wireless device for communicating user identification information as claimed in claim 17 wherein said means for selectively connecting provides options for instantly connecting said devices or storing user identification for future reference at one or more devices or both instantly connecting and storing user identification.

22. A wireless device for communicating user identification information as claimed in claim 17 wherein said means for selectively connecting includes means for connecting said devices through a common interface system.

23. A wireless device for communicating user identification information as claimed in claim 17 wherein said means for selectively connecting provides options for instantly connecting said devices or communicating user identification to a device.

24. A wireless device for communicating user identification information as claimed in claim 17 wherein said device is provided with means for transmitting includes means for compiling or generating signals including at least one parameter to identify users interests.

25. A program product for communicating user identification information for wireless devices comprising a signal generator for setting preferences of said wireless device and generating signals including at least one parameter to identify users interests receiving inputs from compiling means providing its output to a transmitting or receiving means, a comparator receiving its input from said receiving means for identifying one or more devices according to set preference and connector for selectively connecting identified devices.

26. A program product for communicating user identification information for common interface system comprising a receiving means for receiving and storing signal and device information, a comparator receiving its input from said receiving means and stored information for identifying one or more devices according signal parameters and transmitting means for communicating user identification information connector for selectively connecting identified devices.
